(19) United States
(12) Patent Application Publication
(10) Pub. No.: US 2016/0036894 A1
(43) Pub. Date: Feb. 4, 2016

(54) SERVER BASED COMMUNICATION BETWEEN SANDBOXED APPLICATIONS

(71) Applicants: Michael David Collins, Portland, OR (US); David W. Goldman, Portland, OR (US)

(72) Inventors: Michael David Collins, Portland, OR (US); David W. Goldman, Portland, OR (US)

(21) Appl. No.: 14/447,787

(22) Filed: Jul. 31, 2014

(51) Int. Cl. H04L 29/08

(52) U.S. Cl. CPC H04L 67/10; H04L 67/18

(57) ABSTRACT

A remote server facilitates discovery and communication between multiple applications running in respective sandboxes on the same hardware processing device. The remote server determines that the applications are running on the same processing device based on data received from each of the applications. The determination that the applications are running on the same device may include matching corresponding items of information received in data streams from each the applications. The server then transmits, to one of the applications, the identity of each of the applications that have been determined to be running on the processing device. The server then receives a message from the one of the applications to be delivered to another one of the applications that has been determined to be running on the processing device. The server then transmits the message to said other one of the applications, enabling communication of the message between the applications.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay, Inc. All Rights Reserved.

### TECHNICAL FIELD

This application relates generally to multiple sandboxed applications running on a single processing device discovering and communicating with each other, and more specifically to systems and methods for server mediated communication between multiple sandboxed applications that have been determined by a remote server to be running on a same processing device.

### BACKGROUND

The ever-increasing use of mobile devices, such as an iPhone® (from Apple, Inc. of Cupertino, Calif.) or a device running Android™ (from Google, Inc. of Mountain View, Calif.), with data connections, ambient sensors and location determination capabilities is slowly changing the way people interact, shop for products and services, and even manage financial accounts. In order to take advantage of these new possibilities a user of a mobile device may download several applications (Apps) onto the device that facilitate shopping, banking, accessing web based services or otherwise engaging in electronic transactions via a mobile device. However, applications running on a mobile device are often confined to a security “sandbox” that isolates application programs, preventing malicious or malfunctioning programs from damaging or snooping on the rest of your computer system. The sandbox may provide a tightly controlled set of resources for guest programs to run in, so that network access, the ability to inspect the host system or read from input devices are disallowed or heavily restricted. Even desktop computer operating systems run certain applications in a sandbox. For example, most web browsers run web pages you visit in a sandbox that restricts them to running in your browser and accessing a limited set of system resources. Even the browsers themselves may be sandboxed. For example, Google Chrome (from Google, Inc. of Mountain View, Calif.) and Internet Explorer (from Microsoft Corp. of Redmond, Wash.) both run in a sandbox themselves. This sandboxing provides the benefit that, even if a web page was able to take advantage of some security vulnerability of the browser, it would still have to escape the browser's sandbox to do any real damage.

Because applications may be running in a sandbox, it is often difficult to get them to interact seamlessly as a user proceeds through the steps of a more involved electronic transaction that may require multiple applications to fully complete. For example, a user may be prompted for log in information several times as they run several applications. A first application may be used to log into a user account at a merchant web site and browse products that are typically sold and/or auctioned using the “shopping cart” model that allows a customer to select an item from an electronic catalog and then metaphorically add the selected item to a shopping cart. When the customer is done selecting items, the customer requests that the items in the shopping cart be “checked out”. At this point, a payment transaction is initiated, and the purchaser is asked to provide billing information such as a credit card number and other confidential information. A second application might then be used to access a third party online payment service (e.g., PayPal®) for handling payment transactions and at this point the user is usually prompted for log-in information related to the user's online payment service account.

### BRIEF DESCRIPTION OF THE DRAWINGS

Some embodiments are illustrated by way of example and not limitation in the figures of the accompanying drawings in which:

FIG. 1 is a block diagram depicting a system for enabling communication between sandboxed applications on a desktop device or mobile device, according to an example embodiment.

FIG. 2 is a block diagram illustrating an environment for operating a mobile device, according to an example embodiment.

FIG. 3 is a block diagram illustrating the mobile device, as used according to an example embodiment.

FIG. 4 is a block diagram illustrating a network-based system within which communications between sandboxed applications may occur, according to an example embodiment.

FIG. 5 is a block diagram illustrating identification modules, according to an example embodiment.

FIG. 6 is a flowchart illustrating a method for communication between sandboxed applications on a processing device, according to an example embodiment.

FIG. 7 is a flowchart illustrating a method of enabling detection and identification of multiple applications running in sandboxes on a processing device, according to an example embodiment.

FIG. 8 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term “location” is also used within this specification in reference to a physical location associated with an event, such as a vacation destination or an activity such as riding a bicycle.

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Context—For the purposes of this specification and the associated claims, the term “context” is used to refer to environmental inputs (e.g. sensor readings) such as location, time, and weather conditions, among others. The context generally refers to conditions describing an individual's (e.g. user's) environment and/or activities. For example, context information may include a user's location, direction of movement, current activity (e.g. walking, driving, on bicycle, etc.), current weather conditions, time of day, and time of year (e.g. season), among other things. In the following examples, context may be used to determine if multiple applications are operating on a same processing device (e.g. smart phone). For example, a mobile shopping application and a mobile online payment service application may be determined to be running on a same device (and therefore it may be inferred that they are being run by the same user) if the sensor data the applications transmit regarding the device user's environment and/or activities demonstrates that the applications are operating in the same context.

Unique device identifier—Devices using iOS (by Apple of Cupertino, Calif.), like an iPhone or iPod, may employ a Unique Device Identifier (UDID), which is a sequence of 40 letters and numbers that is specific to the device. The 40-character long hex value (20 bytes) could be used by developers to register devices for testing their Apps. For example, developers could run Apps that are not in Apple's AppStore or install beta firmware only on registered devices. However, Apple (of Cupertino, Calif.) has announced that, beginning May 1, 2014, it will automatically reject (from the AppStore) any app updates or new applications that access Universal Device Identifiers. Furthermore, it should be appreciated that any arrangement of data calculated to achieve the same purpose may be substituted for the specific embodiments described herein. For example, a unique device identifier may be coded data registered with a standards organizations, and may include (but is not limited to) the manufacturer of the device, expiry dates, the make and model of the device, and/or any special attributes that the device may possess.

Device fingerprint—A device fingerprint (or machine fingerprint or browser fingerprint) is data collected about a remote computing device for the purpose of identifying said device. Fingerprints may be used to fully or partially identify individual users or devices by collecting, for example, basic web browser configuration information. However, collecting much more esoteric parameter data is possible and aggregating the collected data into a single string may comprise a device fingerprint as used and described herein.

### DETAILED DESCRIPTION

Example systems and methods for enabling multiple applications installed on a single processing device to discover and communicate with each other are described, among other things. Also described are systems and methods for matching multiple applications to a particular device by matching only the recent history of the context of the device as reported by said multiple applications. In some example embodiments, the systems and methods for enabling context matching on a processing device include matching corresponding data from different application data streams, among other things. In the following description, for purposes of explanation, numerous specific details are set forth in order to provide a thorough understanding of example embodiments. It will be evident, however, to one skilled in the art, that the disclosed systems and methods may be practiced without these specific details. It will also be evident that communication between applications running on a same processing device is not limited to the examples provided and may include other scenarios not specifically discussed.

It shall be understood that the disclosed systems and methods are addressed to processing device functionality including mobile processing devices. These mobile devices may include phones such as cellular phones (e.g., iPhone, BlackBerry, Android, Windows, etc.); tablets (e.g., iPad, Galaxy Tab, Kindle Fire, Surface, etc.); a wireless email device; personal digital assistants (PDAs); other devices capable of communicating wirelessly with a computer network or other communication network; or any other type of mobile device that may communicate over a network and handle electronic transactions. A mobile device may be a handheld device. Any mention or discussion herein of processing devices may also be applied to any other mobile devices as provided.

In order to overcome the limitations of sandboxed applications a system might broadcast to all running applications a request to share identification information by sequentially delivering the request to any application that has previously registered interest in such broadcasts. For example, an Intent in the Android mobile operating system (developed by Google, Inc. of Mountain View, Calif.) is an abstract description of an operation to be performed: broadcastIntent may be used to send it to any interested BroadcastReceiver components that have registered interest. However, there is no mechanism for stopping a malicious application from registering for these intents. Furthermore, if a system were to make use of encryption then each sandboxed application that wishes to participate (e.g. register interest) must have the encryption keys available and the keys must be identical for all receivers. Still further, adding a permission parameter to the send does not provide much of an obstacle to an attacker since all receiving applications must declare this in their manifest.

### EXAMPLE SYSTEM

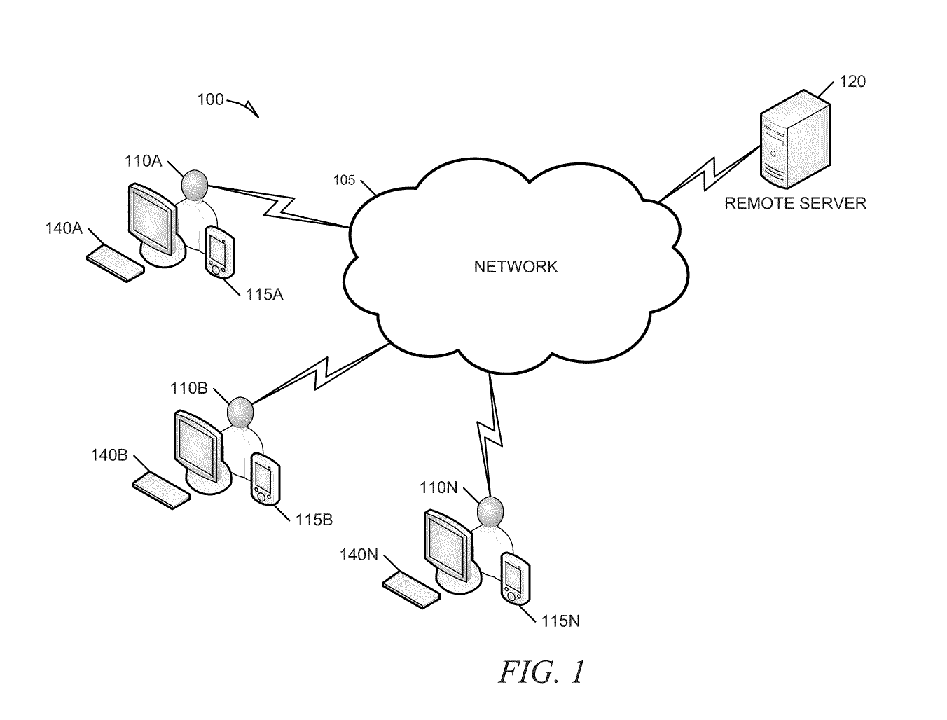

FIG. 1 is a block diagram depicting a system 100, according to an example embodiment, for enabling a plurality of applications running on a single processing device to discover and communicate with each other even if the applications are running in respective sandboxes. In an example, system 100 may include users 110A-110N (collectively referred to as either user 110 or users 110 depending upon context), a network 105 and a remote server 120. In an example, the users 110A-110N may connect to the remote server 120 via mobile devices 115A-115N (collectively referred to as mobile device 115). Users 110A-110N may also connect to the remote server 120 via clients 140A-140N (collectively referred to as client 140 or clients 140).

In an example, the users 110 may run a plurality of applications on each of mobile devices 115 and/or clients 140. Each of the plurality of applications may be run in a “sandbox” such that they may not easily see or communicate with others of the plurality of applications. The remote server 120 may be accessed by each user, such as user 110A, using mobile device 115A or client 140A. For example, a user 110A may run a plurality of applications on a mobile device 115A and these applications may include code to retrieve data from the mobile device 115A and transmit the data to the remote server 120 according to specified access criteria or rules. In an example, the access rules may include user identification (e.g. a unique device identifier) and/or context identification rules (e.g. user must be located within a location supported by the remote server 120).

In an example, the data received by the remote server 120 from each of the plurality of applications respectively may include a unique processing device identifier or a processing device fingerprint. In another example, the data received by the remote server 120 from each of the plurality of applications respectively may include at least one processing device sensor reading. In yet another example, the data received by the remote server 120 from each of the plurality of applications respectively comprises a processing device data stream including at least one device sensor reading. In some examples, the remote server 120 may monitor a user 110's context, including user 110's behavior, via the data received from the plurality of applications running on a mobile device 115.

In some examples, the remote server 120 may determine that the plurality of applications is running on the same device (e.g. mobile device 115) based on the information received from the plurality of applications. In certain examples, the determination includes matching corresponding sensor readings from each of the processing device data streams. In certain examples, the determination includes matching corresponding activity reports from each of the processing device data streams.

### EXAMPLE OPERATING ENVIRONMENT

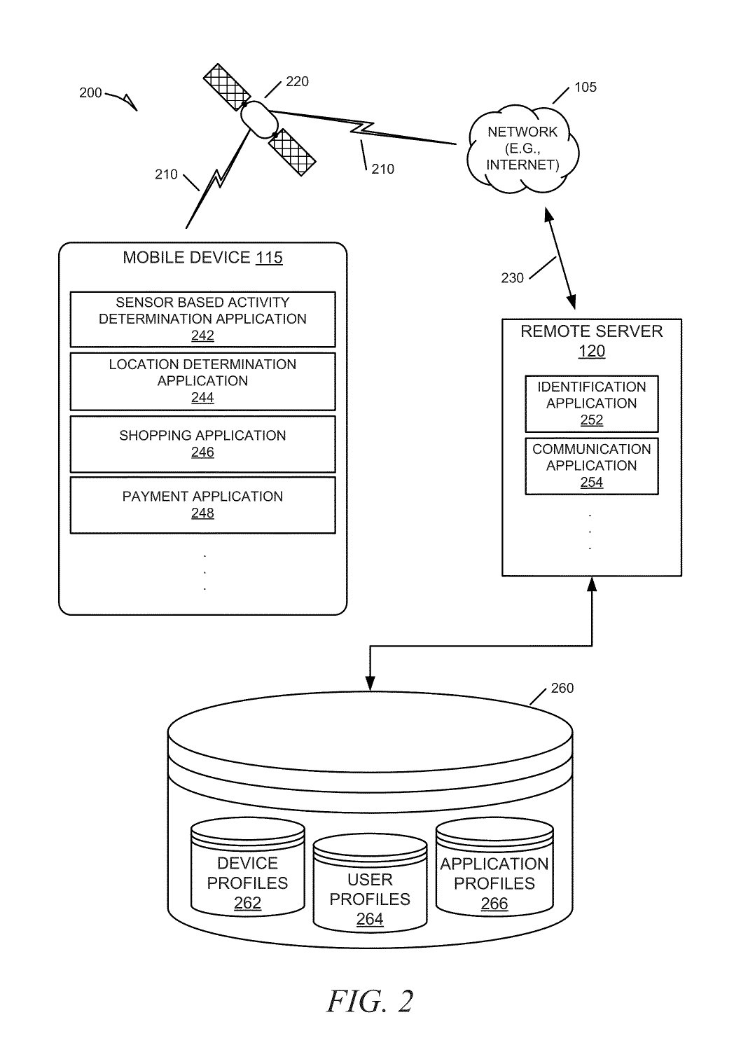

FIG. 2 is a block diagram illustrating an environment 200 for operating a mobile device 115 and remote server 120, according to an example embodiment. The environment 200 is an example environment within which methods for implementing communication between multiple applications running in respective sandboxes on mobile device 115. The environment 200 may include a mobile device 115, wireless communication connections 210, a satellite 220, a communication connection 230, a network 105 (for example the internet), a remote server 120, and a database 260. The mobile device 115 may have multiple applications installed on it, including a sensor based activity determination application 242, a location determination application 244, an online shopping application 246 (e.g. the RedLaser mobile shopping application from eBay Inc. of San Jose Calif.), and an electronic payment application 248 (e.g., PAYPAL payments smart phone application from PayPal, Inc. of San Jose Calif.), as well as others. The database 260 may optionally include device profiles 262, user profiles 264, and/or application profiles 266. The mobile device 115 represents one example device that may be utilized by a user to run multiple software applications, such as shopping application 246. The mobile device 115 may be any of a variety of types of devices (for example, a cellular telephone, a Personal Digital Assistant (PDA), a Personal Navigation Device (PND), a handheld computer, a tablet computer, a notebook computer, or other type of movable device). The mobile device 115 may interface via connections 210 with a network 105. Of course, depending on the form of the mobile device 115 and the remote server 120, any of a variety of types of connections 210 and 230 and networks 105 may be used.

For example, the connections 210 and 230 may be Code Division Multiple Access (CDMA) connection, a Global System for Mobile communications (GSM) connection or other type of cellular connection. Such connections 210 and 230 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 105 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or other types of networks).

In another example, the connections 210 and 230 may be Wireless Fidelity (Wi-Fi, IEEE 802.11x type) connection, a Worldwide Interoperability for Microwave Access (WiMAX) connection, or another type of wireless data connection. In such an embodiment, the network 105 may include one or more wireless access points coupled to a local area network (LAN), a wide area network (WAN), the Internet, or other packet-switched data network.

In yet another example, the connections 210 and 230 may include a wired connection, for example an Ethernet link, and the communication network may be a LAN, a WAN, the Internet, or other packet-switched data network. Accordingly, a variety of different configurations are expressly contemplated.

A remote server 120 may be coupled via connection 230 to the network 105, for example, via wired or wireless interfaces. The remote server 120 may be configured to provide various types of services to the mobile device 115. For example, one or more servers 120 may execute communication applications 254, which interoperate with software executing on the mobile device 115 (e.g. applications 242-248), to provide the ability for applications running on mobile device 115 to discover and communicate with each other securely. Communication application 254 may use knowledge of the processing device that an application is running on to authorize and facilitate communication between the application and other applications that have been determined to be running on the same processing device. The communication may be performed even if the applications are running in sandboxes that limit their access to the resources of mobile device 115, such as the device memory which may not usually be searched by an application running in a sandbox. This makes it difficult to even identify other applications installed on the same mobile device 115, and therefore also makes communication with these other applications challenging.

In an example, a remote server 120 may receive data from each of multiple applications running on a mobile device 115, which data may then be used by an identification application 252 to identify each application. In an example, the data provided to remote server 120 by each of the applications running on mobile device 115 may include a unique application identifier that may be used to uniquely identify each of the applications from which it is received. This identifier (or other information used to identify the application) may be cross-referenced with data from the application profiles 266 in database 260. Alternatively or additionally it may be used to update the application profiles 266 in database 260. In some examples, the data provided to remote server 120 by each of the applications running on mobile device 115 may be used to determine that each of the applications is running on the same processing device, i.e. a mobile device 115. In an example, the data provided to remote server 120 by each of the applications running on mobile device 115 may include a unique device identifier that may be used to uniquely identify the hardware processing device that each of the applications from which it is received is being executed on. This identifier (or other information used to identify the device) may be cross-referenced with data from the device profiles 262 in database 260. Alternatively or additionally it may be used to update the device profiles 266 in database 260.

In an example, the identification application 252 may establish that multiple applications are running on the same physical device by matching unique device identifiers provided by each application so that it is clear which of the applications are running on which of the hardware processing devices, like mobile device 115. In other examples the identification application 252 may establish that multiple applications are running on the same physical device by matching other corresponding pieces of information provided by each application (e.g. a device fingerprint) so that it is again clear which of the applications are running on which of the hardware processing devices, like mobile device 115. In other examples the determination of which applications are running on processing device 115 by identification application 252 may include processing the data received from each application according to algorithms for generating device specific data from the application data. The device specific data may be compared against the data received from each of the application respectively in order to match application to the same specific physical processing device, i.e. mobile device 115.

In an example, upon establishing that multiple applications are running on the same physical device, it may be inferred that they are being run by the same user and therefore data may be exchanged between the applications securely. In some examples, the remote server 120 may transmit, via communication application 254, the identity of each of the applications (e.g. 242, 244, etc.) that has been determined to be running on mobile device 115 to one of the applications running on mobile device 115, e.g. shopping application 246. In an example, communication application 254 of remote server 120 may then receive a message from shopping application 246 for another of the applications running on mobile device 115, e.g. payment application 248. The communication application may then transmit the message to payment application 248 without the need for additional security features such as a shared secret between the communicating applications. A shared secret (e.g. encryption keys) is not required because the communicating applications may each use normal SSL/HTTPS to communicate with the remote server 120 which acts as an intermediate between the communicating applications. Therefore, both legs of the communication channel (e.g. shopping application 246 to remote server 120 and remote server 120 to payment application 248) are secure. The communication channel is secure because the remote server 120 has matched application 246 with application 248 by using the data received from these applications to determine that they are running on the same physical processing device, i.e. mobile device 115.

In an example, the message provided to remote server 120 by the shopping application 246 running on mobile device 115 may include information regarding a user of the shopping application 246 that may be used to authenticate the user to payment application 248 so that the user would not have to enter authentication information such as passwords more than once. The user information may be cross-referenced with data from the user profiles 264 in database 260. Alternatively or additionally it may be used to update the device profiles 264 in database 260.

### EXAMPLE MOBILE DEVICE

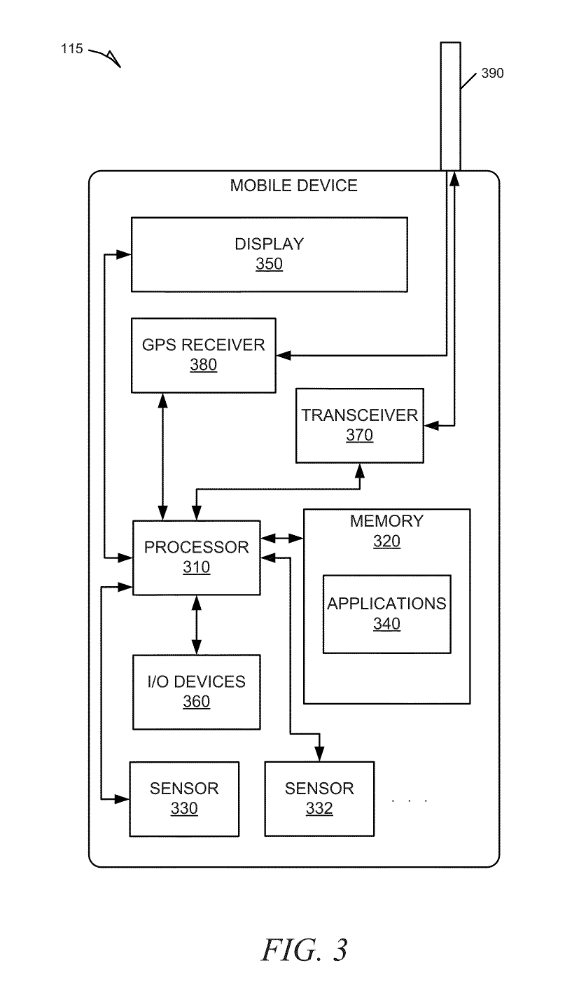

FIG. 3 is a block diagram illustrating an example processing device: mobile device 115, used according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system, as well as application programs 340, such as shopping application 246 of the mobile device 115 shown in FIG. 2. In certain examples, the application programs 340 may include applications that retrieve information from the mobile device like location determination application 244 that may determine the location (e.g. street, city, state, etc.) based on the retrieved information. For example, the location determination application may use data from of a GPS receiver 380 for this purpose. In other examples, a sensor based activity determination application 242 may use data from one of several sensors incorporated into mobile device 115 to generate data regarding the context of the operation of the device, including reports regarding activities the user may be performing while operating the mobile device 115. The sensors in mobile device 115 (e.g. sensors 330, 332, etc.) may provide sensor readings including any combination of the following a: time, temperature, pressure, humidity, orientation, velocity, acceleration, compass bearing, and volume.

The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the network 105 may be established. Further, in some configurations, GPS receiver 380 may also make use of the antenna 390 to receive GPS signals.

### EXAMPLE PLATFORM ARCHITECTURE

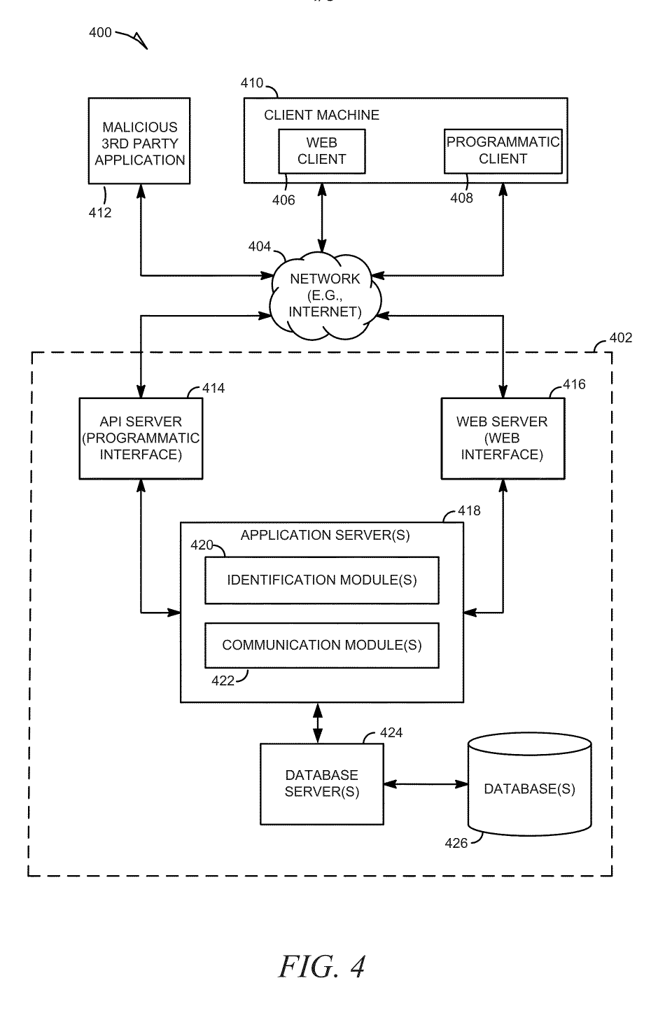

FIG. 4 is a block diagram illustrating a network-based system 400 within which communication between multiple applications running on a client processing machine 410 may discover and communicate with each other via an intermediate remote server system, according to an example embodiment. The block diagram depicts a network-based system 400 (in the exemplary form of a client-server system), within which an example embodiment may be deployed. A networked system 402 is shown, in the example form of a network-based and server-mediated communication system, that provides server-side functionality, via a network 404 (e.g. the Internet or WAN) to one or more client machines 410. FIG. 4 illustrates, for example, a web client 406 (e.g. a browser, such as the Internet Explorer browser developed by Microsoft Corporation of Redmond, Wash. State) and a programmatic client 408 (e.g. PAYPAL payments smart phone application from PayPal, Inc. of San Jose, Calif.) executing on a client machine 410. In an example, the client machine 410 may be in the form of a mobile device, such as mobile device 115. In yet another example, the programmatic client 408 may be the RedLaser mobile shopping application from eBay, Inc. of San Jose, Calif.

An Application Programming Interface (API) server 414 and a web server 416 are coupled to, and provide programmatic and web interfaces respectively to, one or more application servers 418. The application servers 418 host one or more identification modules 420 (in certain examples, these may also include generation modules, matching modules, and a rules engine, to name a few) and communication modules 422. The application servers 418 are, in turn, shown to be coupled to one or more database servers 424 that facilitate access to one or more databases 426. In some examples, the application server 418 may access the databases 426 directly without the need for a database server 424.

The identification modules 420 may provide a number of discovery functions and services to users that access the networked system 402, allowing them to, for example, access information regarding the identity of applications running in respective sandboxes on client machine 410, the identity of client machine 410 or the identity of a user of an application that may be running in a sandbox on the user's processing device, e.g. client machine 410. The communication modules 422 may likewise provide a number of communication services and functions to users. For example, the communication modules 422 may allow a user of client machine 410 to receive information including the identity of all the applications currently being executed in a sandbox on client machine 410, such as an online shopping application or an electronic payment application. The communication modules 422 may also be configured to facilitate communication between applications that may be running in sandboxes on client machine 410. For example, the application server(s) 418 may receive a message from one of the applications running on client machine 410, such as an online shopping application, for another of the applications running on client machine 410, such as an electronic payment application. The communication modules 422 may then forward the message to electronic payment application. In certain examples the message may include information regarding the user of client machine 410 so that the electronic payment application may, for example, authenticate the user without further input from the user.

Further, while the system 400 shown in FIG. 4 employs client-server architecture, the example systems are of course not limited to such an architecture, and could equally well find application in a distributed, or peer-to-peer, architecture system, for example. The various identification modules 420 and communication modules 422 may also be implemented as standalone systems or software programs, which do not necessarily have networking capabilities.

The web client 406 may access the various identification modules 420 and communication modules 422 via the web interface supported by the web server 416. Similarly, the programmatic client 408 accesses the various services and functions provided by the identification modules 420 and communication modules 422 via the programmatic interface provided by the API server 414. The programmatic client 408 may, for example, be a smart phone application (e.g., the PAYPAL payments application) that enables users to process payments directly from their smart phones leveraging user profile data and current location information provided by the smart phone or accessed over the network 404.

FIG. 4 also illustrates a malicious third party application 412, executing on a third party machine, as having access to the networked system 402 via, for example, the programmatic interface provided by the API server 414. The malicious third party application 412 may, utilizing information retrieved from the networked system 402, register itself to receive data intended for applications running in respective sandboxes on client machine 410. In order to prevent the data intended for applications running on client machine 410 from being compromised, one obvious defense is to encrypt the data payload. However, if the payload is encrypted, then each of the sandboxed applications that wishes to participate in receiving the encrypted data must have the encryption keys available and the keys must be identical for all applications that may request and receive the data. Furthermore, in the example of the Android operating system from Google, Inc. of Mountain View, Calif., adding a permission parameter to the sent data does not provide much of an obstacle to a malicious third party application 412 since all of the legitimate applications that may request and receive the data must declare this in their manifest. The malicious third party application 412 may simply obtain the permission information from the manifest of applications that it wishes to mimic. In the server-mediated communication protocol described herein a malicious application must spoof enough of the client-server communication to convince identification module(s) 420 of application server(s) 418 that they are an authentic application, e.g. the eBay shopping application. This may be more difficult for the malicious third party application 412 because each client-server exchange between different applications running on client machine 410 and the application server(s) 418 may use different encryption keys.

### EXAMPLE IDENTIFICATION MODULES

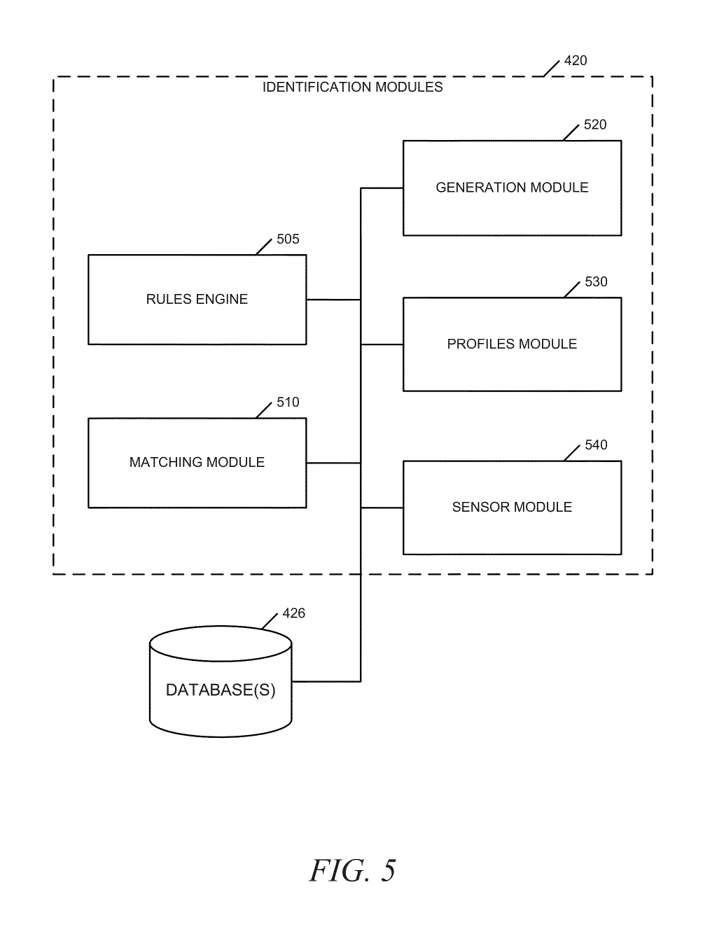

FIG. 5 is a block diagram illustrating identification modules 420, according to an example embodiment. In this example, the identification modules 420 may include a rules engine 505, a matching module 510, a generation module 520, a profiles module 530, and a sensor module 540, among others. In an example, the identification modules 420 may access database 426 to store and/or retrieve generation rules, user profile data, application profile data, device profile data, and location data, as well as other information, to enable discovery and identification of sandboxed applications running on a processing device such as a mobile device 115.

In an example, the rules engine 505 may be configured to manage and evaluate rules controlling how one or more applications (running on mobile device 115 or client 140) may be permitted to access and communicate with the identification modules 420. For example, the rules engine 505 may include rules regarding contextual situations like weather, time of day, time of the year, etc. In an example, the access rules may include user identification (e.g. a unique device identifier) and/or context identification rules (e.g. user must be located within a location supported by the remote server 120).

The matching mobile 510 may be configured to monitor all communications involving the identification modules 420 and determine which communications have been received from the same physical hardware processing device. In an example, the communication module 510 may be configured to match unique processing device identifiers received from sandboxed applications running on mobile device 115 or client 140. In an example, the communication module 510 may be configured to match processing device fingerprints received from sandboxed applications running on mobile device 115 or client 140. In an example, the processing device fingerprint may include any combination of a: country code, device brand, device model, device carrier, IP address, language, OS name, OS version, and timestamp; and the matching module 510 may be configured to match these device fingerprints to a pre-established degree of certainty.

In an example, the communication module 510 may be configured to match processing device sensor readings received from sandboxed applications running on mobile device 115 or client 140. In an example, the processing device sensor readings may include any combination of a: time, temperature, pressure, humidity, orientation, velocity, acceleration, compass bearing, volume, latitude and longitude; and the matching module 510 may be configured to match these sensor readings to a pre-established degree of certainty.

In an example, the communication module 510 may be configured to match processing device data streams received from sandboxed applications running on a mobile device 115 or client 140. In an example, the processing device data streams may include sensor readings sampled from the sensors on processing device and the matching may include matching corresponding sensor reading sampled by different applications running on the processing device. In an example, the processing device data streams may include processed sensor data indicative of the context in which the processing device is being operated, e.g. an activity classification such as is available in iOS (by Apple of Cupertino, Calif.) and Android (by Google Inc. of Mountain View Calif.) and the matching may include matching corresponding contexts (e.g. activity classifications) reported by different applications running on the processing device.

In an example, the generation module 520 is configured to generate device specific data based on application specific data that has been received from the applications running on a mobile device 115 or client 140. For example, since the sensor readings included in the device data streams are actually recording the context in which the processing device is being operated, i.e. measuring what is happening to the device, the activity classifications are reflecting the same physical events or circumstances and with the use of simple mathematics the application specific activity classifications may be used to generate device specific activity classifications, as explained in more detail below.

In an example, the profiles module 530 is configured to provision (e.g. setup) and manage several profile databases within database 426 and also access and cross-reference these databases when needed. For example, if the data provided to remote server 120 includes a unique application identifier, device identifier and/or user identifier that may be used to uniquely identify the application from which it is received, this identifier (or other information used to identify the application, device or user) may be cross-referenced with data from profile databases (like application profiles 266 in database 260) in database 426. Alternatively or additionally it may be used to update the respective profile databases in database 426.

In an example, the sensor module 540 is configured to record the sensor data received from applications running on a mobile device 115 or client 140. In an example, the sensor module 540 may also manage several sensor databases within database 426 and also access and cross-reference these databases when needed. For example, if the data provided to remote server 120 includes a time, temperature, pressure, humidity, orientation, velocity, acceleration, compass bearing, volume, latitude and longitude, this data (or other sensor data) may be cross-referenced with data from the sensor databases in database 426. Alternatively or additionally it may be used to update the respective sensor databases in database 426.

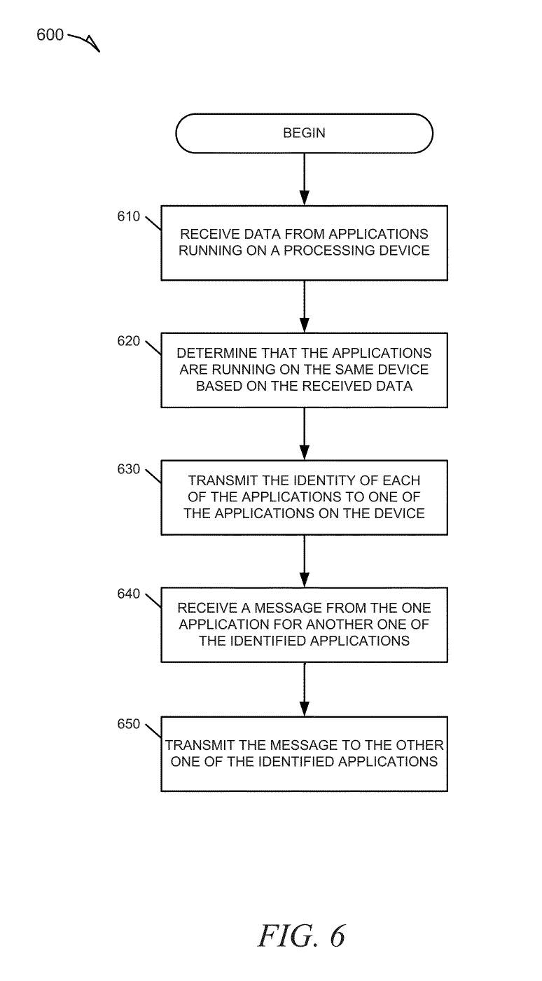

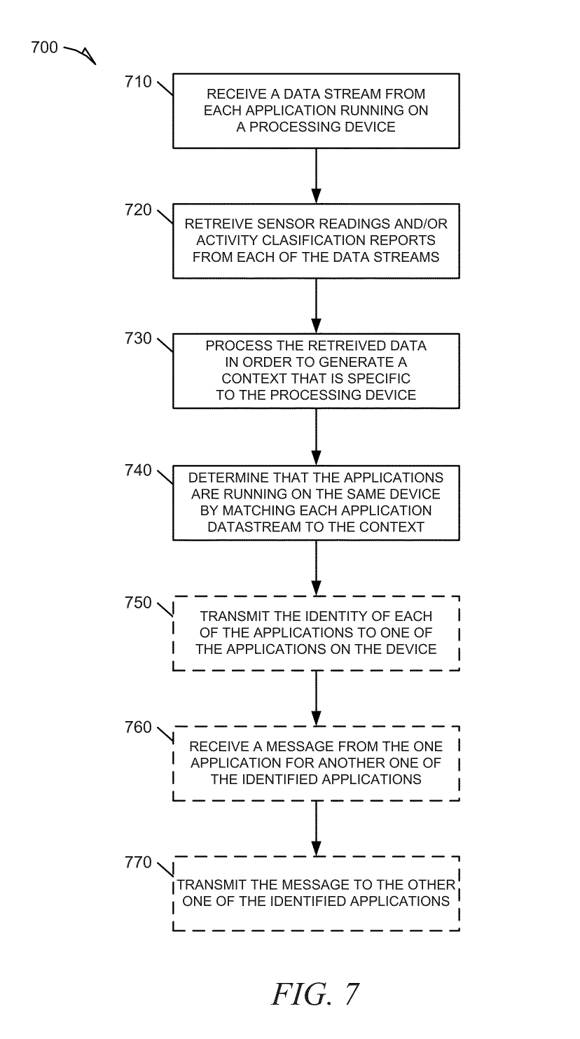

Additional details regarding the functionality provided by the identification modules 420 are detailed in reference to FIGS. 6-7 below.

### EXAMPLE DATA STREAM MATCHING

In an example, a given process (e.g. application) running on a particular device produces a data stream by collecting various sensor readings and appending these to the data stream. In certain examples, the sensors are sampled periodically and in others they are not sampled periodically. In some examples, each process may have different sampling frequencies and also each process may start sampling at a different point in time. Hence the sensor readings appended to the respective data stream for each process may be different even if they are received from processes being executed on the same physical hardware device. However, as noted above, since the data stream includes data that is actually measuring what is happening to the device then each sensor sample may be reflecting the same device context and this may be easily determined by processing the process specific data stream samples and generating a device specific context based on the samples.

In an example, a device data stream may consist of a large set of sensor readings, e.g. modern mobile phones often have temperature, pressure, humidity, accelerometers, compass, microphone, GPS, WiFi antenna etc. In addition, many modern operating systems provide layers of abstraction on top of the raw sensor readings. For example, both iOS (by Apple of Cupertino, Calif.) and Android (by Google Inc. of Mountain View Calif.) provide device activity classification by processing the raw sensor stream readings. In an example, data streams from applications A and B running on a same processing device may include device activity reports (e.g. context) and GPS location reports (e.g. sensor readings). In an example, a data stream from application A might contain the following at a given time:

1391242155109, 3003, 3, 630700

1391242156208, 1003, 45.5463, −122.80136, 32000, 24,

while a data stream from application B for the corresponding time might contain:

1391242155209, 3003, 3, 630700

1391242156408, 1003, 45.5463, −122.80136, 32200, 24.

These streams consist of a sequence of events, one per row; each event has a timestamp with millisecond resolution in the first column, a type code in the second column and finally a body consisting of the remainder of the row. In some examples, two types of contextual events are of direct interest in matching data streams from sandboxed applications running on a same processing device:

| Type Code | Body |
|---|---|
| 1003 | Location report |
| 3003 | Device activity report |

The details of these two types of events are provided below:

| Location Report Items | Meaning |
|---|---|
| Latitude & Longitude | Location |
| Age | How long ago the report was obtained, |
| | in milliseconds |
| Accuracy | How accurate, in meters |

| Activity Report Items | Meaning |
|---|---|
| Activity code | 0 = InVehicle |
| | 1 = OnBicycle |
| | 2 = OnFoot |
| | 3 = Still |
| | 4 = Tilting, orientation is changing but there |
| | is no net motion |
| | 5 = Unclassifiable |
| Duration | How long the device was continuously in |
| | this state, in milliseconds. |

In certain examples, location reports are matched to each other by subtracting the age of the report from the timestamp to directly produce the actual device time when the location report was obtained, i.e. a device specific context. The actual time of a location report is then directly comparable across application data streams for the purpose of matching the streams to a specific hardware processing device. In the above examples, from A's data stream we may compute that the location report was obtained at:

(391242156208−32000)=391242124208,

and from B's data stream we find the report was obtained at

(1391242156408−32200)=391242124208.

Therefore the location reports from A and B may be processed to determine that their device specific context (i.e. actual device time 391242124208) matches to the millisecond and it may therefore be determined that A and B are being executed on a same physical hardware device. In another example, the determination may also or additionally be based on the fact that location data matches to the 5^{th} decimal point in both latitude and longitude.

In an example, the activity reports in data streams from different processes (e.g. applications) running on a single device may have different timestamps for the same activity report. This may be simply because they are being sampled in different processes. This may also be because each process is sampling the current activity of the device on a different schedule. However because the phone actually experienced one activity sequence the durations will be very similar. In the above examples the data stream from application A contain the following at a given time:

1391242155109, 3003, 3, 630700,

while B's stream for the corresponding time contains this

1391242155209, 3003, 3, 630700.

In an example, it may be assumed that, at a maximum, the duration will not differ by more than the sampling interval. Therefore if the sampling interval is set to 30 seconds then a given activity duration, as seen by the different processes, should have differences below 30 seconds. In an example the durations of corresponding activities from data streams received from different processes may then be compared and matched if the difference in their durations is less than the duration of the sampling interval.

### EXAMPLE METHODS

Example methods will be described below; in particular the methods will be described in relation to the previously described figures and elements.

FIG. 6 is a flowchart illustrating a method 600 for server-mediated communication for applications running on a same hardware processing device, according to an example embodiment. In an example, the method 600 may include operations for: receiving data from applications running on a mobile device at 610, determining that the applications are running on the same physical device at 620, transmitting the identity of each application to one of the applications at 630, receiving a message from the one application for another of the identified applications at 640, and transmitting the message to the other one of the applications at 650.

In an example, the method 600 may begin at 610 with the remote server 120 receiving data from each of a plurality of applications (e.g. shopping application 246) running on a mobile device 115 connected to a network 105. In certain examples the data received from each of the applications includes information for uniquely identifying each of the applications respectively. At 620, the method 600 may continue with the remote server 120 determining that each of the plurality of applications is running on the mobile device 115 based, at least in part, on the data received from each of the plurality of applications. For example, the data received from each of the applications may contain a unique device identifier or a device fingerprint for this purpose. At 630, the method 600 may continue with the remote server transmitting the identity of each of the plurality of applications to one of the plurality of applications (e.g. shopping application 246). At 640, the method 600 may continue with the remote server 120 receiving from shopping application 246, in this example, a message for another one of the plurality of applications (e.g. payment application 248). Finally, at 650, the method 600 may include the remote server transmitting the message to the other one of the application, i.e. payment application 248.

FIG. 7 is a flowchart illustrating a method 700 of enabling discovery and communication between multiple applications running on a same processing device by matching corresponding data from data streams received from each of the multiple applications, according to an example embodiment. In an example, the method 700 may include operations for: receiving data streams from each of the applications running on a device at 710, retrieving sensor reading reports and/or activity classification reports from the data streams at 720, generating a device specific context based on the retrieved data at 730, and determining that the applications are running on the same device based on matching each application's data stream to the device specific context at 740. Optionally, the method 700 may also include operations such as: transmitting the identity of each of the applications to one of the applications at 750, receiving a message from the one application for another of the applications at 760, and finally transmitting the message to the other one of the application at 770.

The method 700 may begin at operation 710 with the networked system 402 receiving data streams from each of a plurality applications running on client machine 410 (e.g., from users of a particular application or users registered with the networked system 402). The networked system 402 may also monitor multiple mobile devices, such as mobile devices 115 on client machine 410, in order to facilitate discovery and communication between applications running in sandboxes on these devices. At 720, the method 800 may continue with networked system 402 retrieving information including sensor readings and or activity classifications from the data streams received from each of a plurality applications running on client machine 410.

At 730, the method 700 may continue with the networked system 402 generating, based on the sensor readings and or activity classifications received from the client machine 410, data including a context that is specific to the operation of client machine 410, e.g. user is running, device is within a physical location, ambient temperature, etc. The method 700 may continue at 740, with the networked system 402 determining that the applications providing the data streams are running on a same physical hardware processing device (i.e. client machine 410) by comparing the application data streams to the context to find the data streams that match the context.

Optionally, in order to provide communication functionality, the method 700 may continue at 750 with the remote server transmitting the identity of each of the plurality of applications running on client machine 410 to one of the plurality of applications, e.g. the RedLaser mobile shopping application from eBay via a programmatic client. At 760, the method 700 may continue with the API server 414 receiving, via the programmatic interface, a message from the mobile shopping application for another one of the plurality of applications running on client machine 410, e.g. PAYPAL payments smart phone application from PayPal, Inc. of San Jose Calif. Finally, at 770, the method 700 may include the application server(s) 418 transmitting, via communication module(s) 422 the message to the other one of the application, i.e. the PAYPAL payment application.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry (e.g., a FPGA or an ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures deployed, in example embodiments.

### EXAMPLE ARCHITECTURE AND MACHINE-READABLE MEDIUM

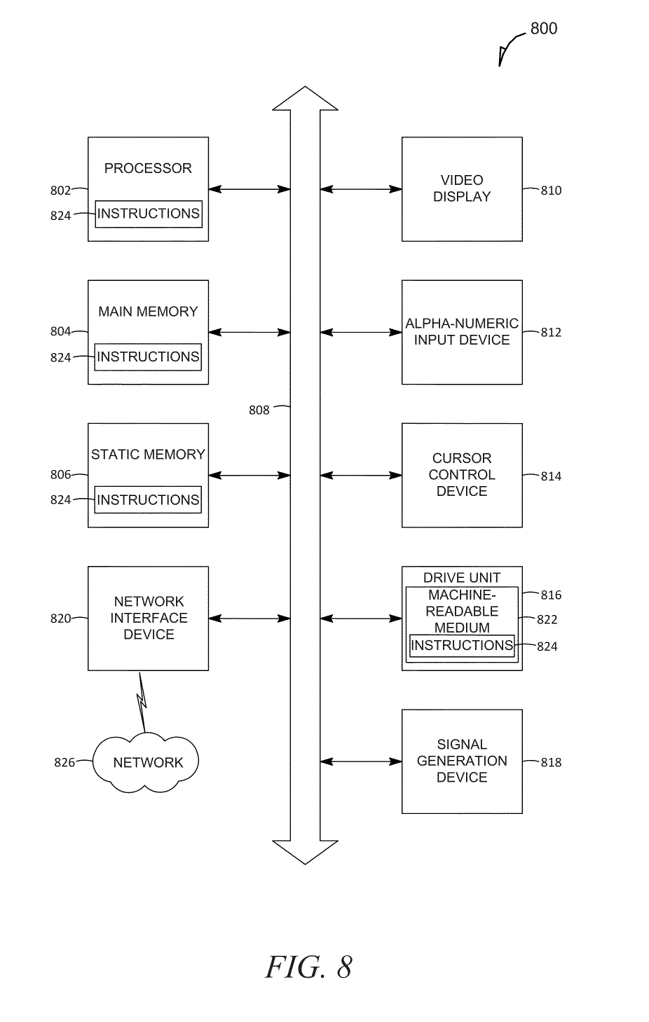

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal displays (LCD) or a cathode ray tube (CRT)). The computer system 800 also includes an alphanumeric input device 812 (e.g., a keyboard), a cursor control (user interface (UI) navigation) device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or used by any one or more of the methodologies or functions described herein. The instructions 824 may also reside, completely or at least partially, within the main memory 804, static memory 806, and/or within the processor 802 during execution thereof by the computer system 800, with the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies disclosed herein, or that is capable of storing, encoding or carrying data structures used by or associated with such instructions. The term “machine-readable medium” shall accordingly be taken to include, but not be limited to, solid-state memories and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for discovery and communication between applications running in sandboxes on a processing device has been described. Although the present disclosure includes references to specific example embodiments, it will be evident that various modifications and changes may be made to these embodiments without departing from the broader spirit and scope of the present disclosure. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
receiving, by a remote server, data from each of a plurality of applications running on a processing device connected to a computer network, their respective data identifying each of the plurality of applications;
determining, by the remote server, that each of the plurality of applications is running on the processing device based, at least in part, on the data received from each of the plurality of applications;
transmitting, by the remote server to one of the plurality of applications, the identity of each of the plurality of applications.

2. The method of claim 1, further comprising:
receiving, by the remote server from the one of the plurality of applications, a message for another one of the plurality of applications; and
transmitting the message from the remote server to the other one of the plurality of applications.

3. The method of claim 1, wherein the data received by the remote server from each of the plurality of applications respectively includes a unique processing device identifier.

4. The method of claim 1, wherein the data received by the remote server from each of the plurality of applications respectively includes a processing device fingerprint.

5. The method of claim 4, wherein the processing device fingerprint includes at least one of a: country code, device brand, device model, device carrier, IP address, language, OS name, OS version, and timestamp.

6. The method of claim 1, wherein the data received by the remote server from each of the plurality of applications respectively includes at least one processing device sensor reading.

7. The method of claim 6, wherein the processing device sensor reading includes one of a: time, temperature, pressure, humidity, orientation, velocity, acceleration, compass bearing, volume, latitude and longitude.

8. The method of claim 6, wherein the data received by the remote server from each of the plurality of applications respectively comprises a data stream including at least one processing device sensor reading.

9. The method of claim 8, wherein the determining includes matching corresponding sensor readings from each of the processing device data streams.

10. The method of claim 6, wherein the data received by the remote server from each of the plurality of applications respectively comprises a data stream including at least one device activity report based on at least one processing device sensor reading.

11. The method of claim 10, wherein the determining includes matching corresponding device activity reports from each of the data streams.

12. A system comprising:
a processing device connected to a network; and
a remote server configured to:
receive data streams from each of a plurality of applications running on the processing device, their respective data identifying each of the plurality of applications;
retrieve at least one of a device sensor report and a device activity report from each of the data streams;
generate data including a context that is specific to the processing device based on that at least one report from each of the data streams; and
determine that the plurality of applications are running on the processing device based, at least in part, on matching the data streams received from each of the plurality of applications to the context.

13. The system of claim 12, wherein the remote server is configured to:
transmit, to one of the plurality of applications, the identity of each of the plurality of applications;
receive, from the one of the plurality of applications, a message for another one of the plurality of applications; and
transmit the message to the other one of the plurality of applications.

14. The system of claim 12, wherein the processing device sensor reading includes one of a: time, temperature, pressure, humidity, orientation, velocity, acceleration, compass bearing, volume, latitude and longitude.

15. The system of claim 14, wherein the device sensor report comprises a location report including a timestamp and a duration.

16. The system of claim 15, wherein the context is generated by subtracting the age of the device sensor report from the timestamp to obtain the actual device time when the location was reported.

17. A machine-readable storage medium including instructions that, when executed on a remote server, cause the server to:
receive data from each of a plurality of applications running on a processing device connected to a computer network, their respective data identifying each of the plurality of applications;
determine that the plurality of applications are running on the processing device based, at least in part, on the data received from each of the plurality of applications;
transmit, to one of the plurality of applications, data including the identity of each of the plurality of applications;
receive, from the one of the plurality of applications, a message for another one of the plurality of applications; and
transmit the message to the other one of the plurality of applications.

18. The machine-readable storage medium of claim 17, wherein the data received by the remote server from each of the plurality of applications respectively comprises a data stream including at least one device sensor reading and the determining includes matching corresponding sensor readings from each of the data streams.

19. The machine-readable storage medium of claim 17, wherein the data received by the remote server from each of the plurality of applications respectively comprises a data stream including at least one activity report based on at least one device sensor reading.

20. The machine-readable storage medium of claim 19, wherein the determining includes matching corresponding activity reports from each of the data streams.
